(19) United States
(12) Patent Application Publication
(10) Pub. No.: US 2005/0121578 A1
(43) Pub. Date: Jun. 9, 2005

(54) Locking joint for support arm

(76) Inventors: Saeb Asamarai, Columbia Heights, MN (US); Khalid Alzebdeh, Apple Valley, MN (US); Robert W. Fluhrer, Prior Lake, MN (US); John W. Theis, St. Paul, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/927,969

(22) Filed: Aug. 27, 2004

Related U.S. Application Data
(60) Provisional application No. 60/498,471, filed on Aug. 27, 2003.

(51) Int. Cl. E06B 7/28

(52) U.S. Cl. 248/284.1; 248/292.12; 248/921

(57) ABSTRACT

A locking joint device and method is provided. Embodiments of joint devices provided include selective adjustment to a user. Also provided is a selective locking joint that securely locks a position of a joint such as an elevation joint, once a position is selected. Embodiments of joints are provided with a simple design that is inexpensive to manufacture.

This application claims priority to U.S. Provisional Application No. 60/498,471 filed Aug. 27, 2003 which is incorporated herein by reference.

### FIELD OF THE INVENTION

This application relates to devices and methods for moveably supporting equipment. Specifically, but not by way of limitation, this application relates to devices and methods for supporting display screens such as flat panel display screens for use with personal computers.

### BACKGROUND

In many fields, it is useful to support equipment in such a way to make the position of the equipment adjustable. In particular, flat panel display screens for personal computers are gaining popularity with consumers. It is desirable for users of personal computers to be able to position their computer screens, such as flat panel screens in orientations that are ergonomically correct.

Although embodiments of the present invention can be used with several different adjustment joints, an elevation joint is used as an example. An elevation adjustment is useful to provide flexibility for users of different heights. One common elevation adjustment includes an arm configuration with a joint between two arm portions. A user can extend a distal arm portion upwards or downwards by rotating the distal arm in relation to a base arm portion about an elevation joint.

It is inconvenient for the user if the equipment, such as the flat panel display, does not stay in the intended position. Unwanted motion can be caused by the elevation joint being too loose, with the equipment moving under its own weight. Unwanted motion can also be caused by inadvertent bumping of the arm or supported equipment. Further, if the elevation joint moves an excessive amount, the supported equipment, such as the flat panel display, may become damaged by hitting a surface such as a desktop.

What is needed is an improved support arm that provides adjustability. What is also needed is an improved support arm that reduces unwanted motion of adjustment joints such as elevation joints.

### BRIEF DESCRIPTION OF THE DRAWINGS

FIG. 1 shows a support arm according to an embodiment of the invention.

FIG. 2 shows an exploded view of a joint according to an embodiment of the invention.

FIG. 3 shows another exploded view of a joint according to an embodiment of the invention.

FIG. 4 shows an engaging device according to an embodiment of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical changes, etc. may be made without departing from the scope of the present invention. In the following description, unless otherwise provided, the term “locked” is defined for joint motion as being fixed in a position until an actuator device releases a locked condition. This is in contrast to detent configurations, or spring biased conditions that require additional force to overcome a barrier to motion of a joint.

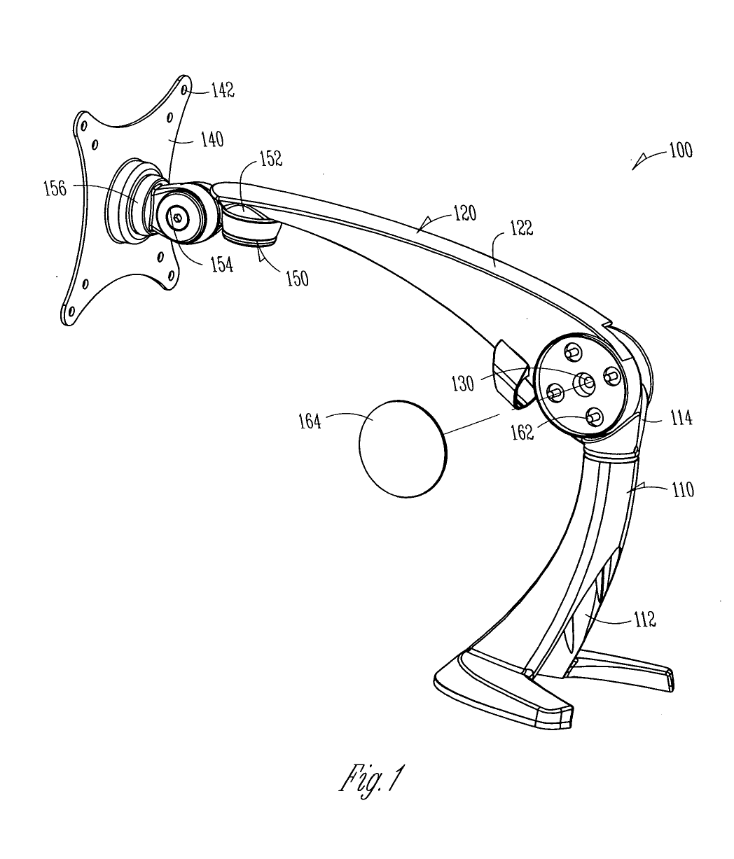

FIG. 1 shows a support arm 100 according to an embodiment of the invention. In one embodiment, selected components of the support arm are fabricated from cast aluminum. Other materials such as steel, polymers, etc. are also within the scope of the invention. Likewise, other fabrication methods such as forging, CNC machining, etc. are also within the scope of the invention.

The support arm 100 includes a first arm portion 110 and a second arm portion 120. In one embodiment, the first arm portion 110 includes a base portion 112 and an upper portion 114. In one embodiment, the base portion 112 and the upper portion 114 are coupled together mechanically. In one embodiment, the base portion 112 and the upper portion 114 are integrally formed.

The second arm portion 120 includes a main arm 122. In one embodiment, other adjustment components 150 such as rotation joints are also included with the second arm portion 120. The embodiment of FIG. 1 includes a first axis joint 152, a second axis joint 154, and a third axis joint 156.

An equipment support 140 is further shown in FIG. 1 with a number of attachment holes 142. In one embodiment, the equipment support 140 is adapted to mount a flat panel display screen such as used with personal computers, although the invention is not so limited. In another option, the equipment support 140 is integral to the display screen.

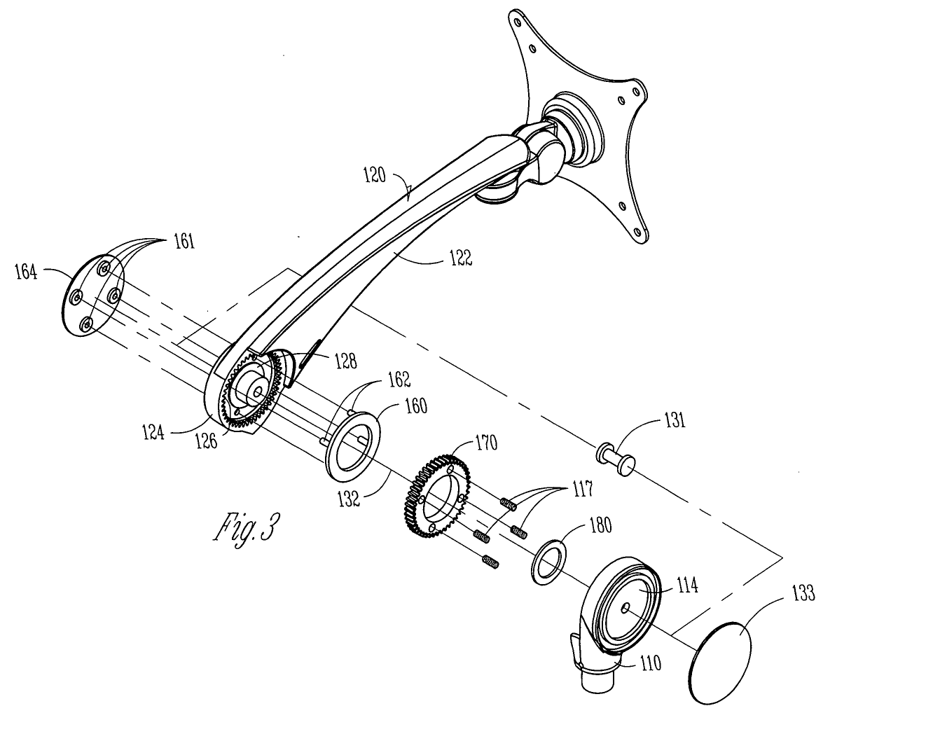

An elevation joint 130 is shown between the first arm portion 110 and the second arm portion 120. When actuated, the elevation joint 130 allows a user to adjust a height of the equipment support 140. A number of actuating pins 162 are further shown in FIG. 1. The actuating pins will be discussed in more detail below. In one embodiment, a cover 164 is included and is attached over the actuating pins 162 as shown by the arrow in FIG. 1. Optionally, the cover 164 includes recesses 161 sized and shaped to receive the pins 162, as shown in FIG. 3. Although in one embodiment, the cover 164 is used to actuate the actuating pins 162, other configurations such as mechanical linkages, buttons, etc. are also acceptable to actuate the actuating pins 162.

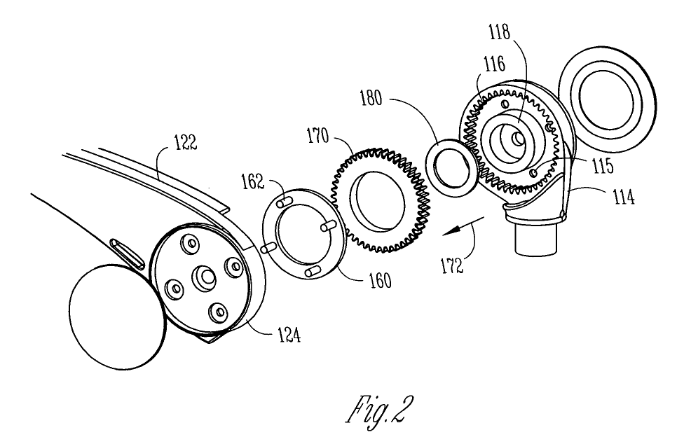

FIG. 2 shows details of components between the first arm portion 110 and the second arm portion 120. A first engaging feature 116 is shown on the upper portion 114 of the first arm portion 110. In one embodiment, the first engaging feature includes a number of teeth. In one embodiment, the number of teeth are formed in a female configuration to accept an engaging device 170. Although a number of teeth are shown in FIG. 2, one of ordinary skill in the art, having the benefit of the present disclosure, will recognize that several geometries of engaging features are possible. For example, square features, triangular, other polygons, etc. In one embodiment, a number of teeth are used to provide a high number of possible rotational selections within the first engaging feature 116.

A first friction surface 118 is also shown on the upper portion 114 of the first arm portion 110. In one embodiment, the first friction surface 118 is adapted to mate with a friction insert such as a friction washer 180. Although a washer configuration is shown, other geometries of inserts are possible to provide frictional resistance between surfaces in the elevation joint 130.

An engaging device 170 is further shown in FIG. 2 that is adapted to engage the first engaging feature 116 of the first arm 110. As described above, in one embodiment, a toothed configuration, such as a gear is used to provide a high number of possible rotational selections.

A number of features 115 such as pockets are further shown as part of the first arm portion 110. In one embodiment, a number of compression springs 117 (FIG. 3) are placed within the features 115. The number of compression springs 117 are adapted to urge the engaging device 170 along direction 172. Although the compression springs 117 are used in one embodiment, other urging devices, such as other spring varieties, elastomer inserts, etc. are also possible within the scope of the invention.

An actuating device 160 is also shown in FIG. 2. In one embodiment, the actuating device includes a number of actuating pins 162. In operation, the actuating device bears against the engaging device 170. When the actuating pins 162 are pressed, the engaging device 170 is forced farther into the first engaging feature 116 against the urging force of components such as compression springs discussed above. Although three actuating pins are shown, other numbers of actuating pins are also within the scope of the invention. Likewise, components other than pins, such as linkages, etc. that operate to displace the engaging device 170 are also within the scope of the invention.

FIG. 3 shows another view of components between the first arm portion 110 and the second arm portion 120. A joint axis 132 of the elevation joint 130 (FIG. 1) is shown. A second engaging feature 126 is shown on a joint end 124 of the main arm 122. Similar to the first engaging feature, in one embodiment, the second engaging feature 126 includes a number of teeth. In one embodiment, the number of teeth are formed in a female configuration to accept the engaging device 170. Although a number of teeth are shown in FIG. 3, one of ordinary skill in the art, having the benefit of the present disclosure, will recognize that several geometries of engaging features are possible. For example, square features, triangular, other polygons, etc. In one embodiment, a number of teeth are used to provide a high number of possible rotational selections within the second engaging feature 126.

A second friction surface 128 is also shown in FIG. 3. In one embodiment, a friction washer 180 engages both the first friction surface 118 and the second friction surface 128 to provide smooth and controlled movement between the first arm portion 110 and the second arm portion 120. In one embodiment, the friction washer 180 includes a polymer friction washer. In one embodiment, the friction washer 180 includes an ultra high molecular weight polyethylene washer. As discussed above, although a washer is shown, other shapes of material that provide a friction function are within the scope of the invention.

In one embodiment, the first arm portion 110 and the second arm portion 120 are secured together using a fastener 131 that is inserted through openings along the axis 132 as shown in FIG. 3. Several options are possible for the fastener 131, including a nut and bolt, a rivet, or other mechanical fastening systems. Because the joint 130 as described in embodiments above is selectively locked in place by the engaging device 170, a tension of the fastener 131 is less critical than in non-locking designs. A fastener only needs to provide adequate tension for smooth operation between the first friction surface 118 and the second friction surface 128. Use of the friction washer 180 further provides some degree of leeway in acceptable fastener tension during manufacturing. In one embodiment, use of a rivet as a fastener is possible because of the less critical fastener tension. One of ordinary skill in the art, having the benefit of the present disclosure will recognize that use of a rivet is less expensive for manufacturing than use of a nut and bolt. A second cover 133 is provided in one option to at least partially cover a portion of the fastener 131.

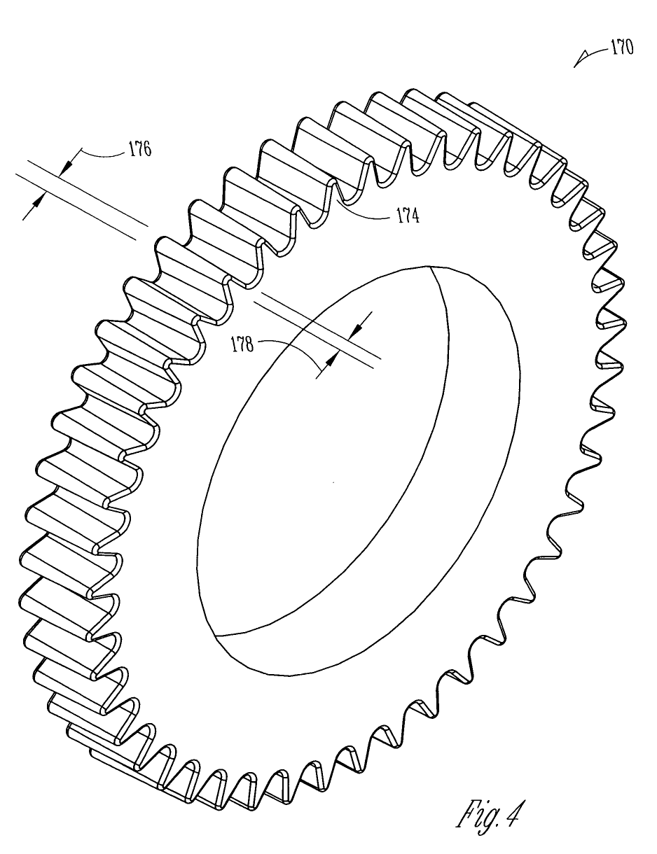

FIG. 4 shows one embodiment of an engaging device 170. As discussed above, in one embodiment, the engaging device 170 includes a toothed gear. In one embodiment, each tooth 174 includes an asymmetric profile. As shown in FIG. 4, in one embodiment, one side of the teeth 174 have a first width 176 and the other side of the teeth 174 have a second, thinner width 178. In one embodiment, the difference in widths provides a taper to the teeth 174. Although a taper is described in the context of teeth, one of ordinary skill in the art, having the benefit of the present disclosure, will recognize that a taper can be used on other geometries of engaging devices. In one embodiment, the engaging device 170 is oriented so that the thinner width 178 faces the second engaging feature 126.

In operation, the elevation joint 130 includes two conditions, locked and unlocked. The condition of the elevation joint 130 is determined by a position of the engaging device 170. The engaging device 170 is allowed to move within a range of motion within the elevation joint 130. In one embodiment, the engaging device is further biased using compression springs as described above to be normally in a selected portion of the range of motion.

In one embodiment, in the normal biased portion of the range of motion the elevation joint is locked. In one embodiment, in the normal biased portion of the range of motion, the engaging device 170 engages both the first engaging feature 116 and the second engaging feature 126.

When the actuating pins 162 are pushed, the actuating device 160 displaces the engaging device 170 into the first engaging feature 116 to a second location in the range of motion so that only the first engaging feature 116 is engaged by the engaging device 170. When the engaging device 170 is in the second location, the elevation joint 130 is in the unlocked state, and the second arm portion 120 is therefore free to rotate about the joint axis 132.

When the actuating pins are released, compression springs as described above urge the engaging device 170 back so that the elevation joint is in a normally locked state. In one embodiment, the cover 164 is used to depress the actuating pins 162 at the same time. In one embodiment, the cover 164 is attached to the actuating pins using a suitable attachment method such as adhesive, mechanical attachment, etc. As discussed above, other configurations such as mechanical linkages, buttons, etc. are also acceptable to depress the actuating pins 162.

In one embodiment, the taper as described above, and shown in FIG. 4, enhances engagement of the engaging device 170 into the second engaging feature 126 to put the elevation joint 130 back into the locked state. The taper reduces the probability of an alignment error between the engaging device 170 and the second engaging feature 126. In one embodiment, because the engaging device 170 is always at least partially engaged in the first engaging feature 116, there is no alignment error issue between the engaging device 170 and the first engaging feature 116.

### Conclusion

Using embodiments described above, a number of advantages are realized. One advantage includes a simple, joint device that provides selective adjustment to a user. In one example, embodiments described above provide an adjustable elevation joint. Another advantage of embodiments described above includes a selective locking joint that securely locks a position of a joint such as an elevation joint, once a position is selected. A locking joint provides security against unwanted movement of a joint. Another advantage of embodiments described above includes a simple design that is inexpensive to manufacture. In selected embodiments, features such as first and second engaging features are integrally cast into components. Integral forming reduces a number of parts required for manufacture, which in turn reduces cost. As discussed above, a further cost advantage is obtained in selected embodiments though the use of fasteners such as rivets in place of nuts and bolts.

Although selected advantages are detailed above, the list is not intended to be exhaustive. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used.

1. An apparatus comprising:
a first arm portion, having a first engaging feature;
a second arm portion, having a second engaging feature;
a pivot joint coupling the first and second arm portion; and
an engaging device adapted to move within a range of motion, the range of motion including:
a first position where the engaging device engages both the first engaging feature and the second engaging feature to lock rotation of the pivot joint; and
a second position where the engaging device engages only one of the engaging features to permit rotation about the pivot joint.

2. The apparatus of claim 1, wherein the first and second engaging features include alternating recesses and teeth.

3. The apparatus of claim 2, wherein the engaging device is sized and shaped to engage against the teeth of the first and second engaging features.

4. The apparatus of claim 2, wherein the engaging device includes corresponding recesses and teeth, and the corresponding teeth are sized and shaped to engage against the teeth of the first and second engaging features.

5. The apparatus of claim 4, wherein the engaging device includes a first surface and a second surface and profiles of the corresponding teeth extend between the first and second surfaces.

6. The apparatus of claim 5, wherein the profiles of the corresponding teeth taper from a first width to a second width between the first and second surfaces.

7. The apparatus of claim 1, further comprising an actuating member coupled between the engaging device and at least one of the first and second engaging features, wherein the actuating member is adapted to move the engaging device between the first position and the second position.

8. The apparatus of claim 7, wherein the actuating member includes a pin extending through at least one of the first and second arm portions.

9. The apparatus of claim 8, further comprising a cover coupled to the pin, wherein the cover is adapted to move the actuating member.

10. The apparatus of claim 1, further comprising at least one biasing member coupled between the engaging device and at least one of the first arm portion and the second arm portion, wherein the at least one biasing member biases the engaging device toward the first position.

11. The apparatus of claim 10, wherein the at least one biasing member includes a compression spring.

12. The apparatus of claim 1, wherein the first arm portion includes a first friction surface, and the second arm portion includes a second friction surface, and the first and second friction surfaces are adapted to moveably communicate.

13. The apparatus of claim 12, further comprising a friction washer coupled between the first and second friction surfaces.

14. An apparatus comprising:
a first arm portion;
a second arm portion rotatably coupled to the first arm portion;
means for locking rotation of the second arm portion relative to the first arm portion.

15. The apparatus of claim 14, wherein the means for locking rotation of the second arm portion includes an engaging device coupled between the first and second arm portions, and the engaging device is adapted to move within a range of motion, the range of motion including:
a first position where the engaging device engages both the first and second engaging features to lock rotation of the second arm portion relative to the first arm portion; and
a second position where the engaging device engages only one of the engaging features to permit rotation of the second arm portion relative to the first arm portion.

16. The apparatus of claim 15, wherein the first and second engaging features include alternating recesses and teeth.

17. The apparatus of claim 16, wherein the engaging device is sized and shaped to engage against the teeth of the first and second engaging features.

18. The apparatus of claim 16, wherein the engaging device includes corresponding recesses and teeth, and the corresponding teeth are sized and shaped to engage against the teeth of the first and second engaging features.

19. A display screen system comprising:
a first arm portion;
a second arm portion rotatably coupled to the first arm portion;
an equipment support coupled substantially adjacent to an end of the second arm portion, wherein the equipment support is sized and shaped to support a display screen; and
an engaging device coupled between the first and second arm portions, wherein the engaging device is adapted to move within a range of motion, the range of motion including:
a first position where the engaging device engages both the first and second engaging features to lock rotation of the second arm portion relative to the first arm portion; and
a second position where the engaging device engages only one of the engaging features to permit rotation of the second arm portion relative to the first arm portion.

20. The display screen system of claim 19, wherein the first and second engaging features include alternating recesses and teeth.

21. The display screen system of claim 20, wherein the engaging device is sized and shaped to engage against the teeth of the first and second engaging features.

22. The display screen system of claim 19, wherein the equipment support is separate from the display screen.

23. A method comprising:
rotatably coupling a first arm portion to a second arm portion, wherein the first arm portion includes a first engaging feature and the second arm portion includes a second engaging feature; and
moveably coupling an engaging device between the first and second engaging features, wherein the engaging device is adapted to move within a range of motion including:
a first position where the engaging device engages both the first and second engaging features to lock rotation of the second arm portion relative to the first arm portion,
a second position where the engaging device engages only one of the first and second engaging features to permit rotation of the second arm portion relative to the first arm portion.

24. The method of claim 23, further comprising coupling an actuating member between the engaging device and at least one of the first and second engaging features.

25. The method of claim 24, further comprising coupling a cover to the actuating member.

26. The method of claim 23, wherein moveably coupling an engaging device between the first and second engaging features includes engaging corresponding teeth of the engaging device against teeth of at least one of the first and second engaging features.

27. The method of claim 26, wherein engaging corresponding teeth of the engaging device includes engaging first portions of the corresponding teeth with the first engaging feature, and engaging second portions of the corresponding teeth with the second engaging feature, and profiles of the corresponding teeth taper from the first portions to the second portions.

28. The method of claim 23, further comprising coupling an equipment support proximate to a distal end of the second arm portion.

29. The method of claim 23, further comprising moveably coupling a first friction surface with a second friction surface, wherein the first arm portion includes the first friction surface and the second arm portion includes the second friction surface.

30. The method of claim 29, wherein moveably coupling the first friction surface with the second friction surface includes coupling a friction washer between the first and second friction surfaces.
